(19) United States
(12) Patent Application Publication
(10) Pub. No.: US 2023/0150111 A1
(43) Pub. Date: May 18, 2023

(54) Multi-Purpose Grabbing Device

(71) Applicant: Laura Ann Rand, Tallahassee, FL (US)

(72) Inventor: Laura Ann Rand, Tallahassee, FL (US)

(21) Appl. No.: 17/571,601

(22) Filed: Jan. 10, 2022

Related U.S. Application Data
(60) Provisional application No. 63/279,339, filed on Nov. 15, 2021.

(51) Int. Cl. B25J 1/02

(52) U.S. Cl. CPC B25J 1/02

(57) ABSTRACT

The present invention relates generally to the field of grabbing devices. More specifically, the present invention relates to a multi-purpose grabbing device that is comprised of a first end, an exterior shaft with at least one internal spring and a second end. The first end is further comprised of a handle assembly with a trigger and at least one locking button. The second end is further comprised of a claw assembly. In differing embodiments, the shaft may be of a fixed length or may have an interior shaft that allows the shaft to become adjustable. The device is also comprised of a claw assembly capable of grasping a nail or other object that is operated from its other end. In this manner, the device can be applied to any overhead task such that the user can reduce stress and strain in the shoulder joint while still completing the overhead task.

### CROSS-REFERENCE TO RELATED APPLICATION

The present application claims priority to, and the benefit of, U.S. Provisional Application No. 63/279,339 which was filed on Nov. 15, 2021 and is incorporated herein by reference in its entirety.

### FIELD OF THE INVENTION

The present invention relates generally to the field of grabbing devices. More specifically, the present invention relates to a multi-purpose grabbing device that is comprised of a first end, an exterior shaft with at least one internal spring and a second end. The first end is further comprised of a handle assembly with a trigger and at least one locking button. The second end is further comprised of a claw assembly. In differing embodiments, the shaft may be of a fixed length or may have an interior shaft that allows the shaft to become adjustable. The device is also comprised of a claw assembly capable of grasping a nail or other object that is operated from its other end. In this manner, the device can be applied to any overhead task such that the user can reduce stress and strain in the shoulder joint while still completing the overhead task. Accordingly, the present disclosure makes specific reference thereto. Nonetheless, it is to be appreciated that aspects of the present invention are also equally applicable to other like applications, devices and methods of manufacture.

### BACKGROUND

Many at-home tasks require shoulder strength, shoulder stability and significant range of motion in the shoulder. The shoulder joint is one of the most complex parts of the human body and can be difficult to maintain with constant wear and tear over a lifetime of use. As people get older, doing tasks above the head often become a major obstacle as things like arthritis, injuries and surgeries in the shoulder make it difficult for previously simple tasks, such as hanging a picture, to be completed without significant pain and physical impairment. Completing tasks above the head becomes even more difficult when both hands are required for the task instead of using an unused hand to help stabilize the other parts of the body.

Therefore, there exists a long-felt need in the art for a multi-purpose grabbing device. There also exists a long-felt need in the art for a grabbing device that eases the strain on shoulders when completing overhead tasks. Further, there exists a long-felt need in the art for a multi-purpose grabbing device that can act as an extension of an arm to reach higher places and attach and detach to various objects. In addition, there exists a long-felt need in the art for a multi-purpose grabbing device that can accommodate users of all lengths and sizes.

The subject matter disclosed and claimed herein, in one embodiment thereof, comprises a multi-purpose grabbing device. The device is comprised of a first end, an exterior shaft with at least one internal spring and a second end. The first end is further comprised of a handle assembly with a trigger and at least one locking button. The second end is further comprised of a claw assembly. The claw assembly is capable of grasping a nail or other object such that the device can be used during an overhead task such that the user can reduce stress and strain in the shoulder joint while still completing the overhead task without having to bring his or her arms above his or her head.

In this manner, the multi-purpose grabbing device of the present invention accomplishes all the forgoing objectives and provides an improved means to grab out-of-reach objects. Further, the device decreases the stress and strain on the shoulder joint by extending out from the arm such that the user may not have to reach his or her arm much higher than above his or her head. In addition, the device can extend to multiple lengths, accommodating users of any length and size.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-purpose grabbing device. The device is primarily comprised of body further comprised of a first end, an exterior shaft with at least one internal spring and a second end. The first end is further comprised of a handle assembly with a trigger and at least one locking button. The second end is further comprised of a claw assembly. The body may also be made of a plurality of materials. However, the body is preferably made of a flexible or semi-flexible plastic material. In addition, any surface of the body may be comprised of a plurality of indicia such as patterns, logos, emblems, images, symbols, designs, letters, words, characters, animals, advertisements, brands, etc.

An exterior shaft of the body connects a first end to a second end of the device. The body may be a of a fixed length or adjustable in length, such that an interior shaft extends from an exterior shaft. In the embodiment with an adjustable length, the exterior shaft has a plurality of continuous openings along its surface in which spring-loaded locking tabs on the surface of the interior shaft insert to temporarily give the device a fixed length. A locking button may also be found along the length of the exterior shaft that prevents the spring-loaded locking tabs from exiting the continuous openings, locking the length of the device.

The first end of the shaft further comprises a handle assembly. A trigger of the handle assembly controls the tension in a spring that connects to the hinge of the claw assembly. By pressing the trigger, tension in the spring increases and the claw assembly closes. When the trigger is released, tension in the spring decreases and the claw assembly may open. A locking button of the handle assembly may be activated such that when the trigger is released, tension in the spring does not decrease, thereby keeping the claw assembly closed and secured onto an abject. In one potential embodiment, a trigger guard may also be present on the handle assembly to prevent the trigger from being activated unintentionally. Further, a generally L-shaped handle acts as the gripping point for the hand of the user and the main point from which the user can operate the device.

The second end of the shaft is further comprised of the claw assembly. Two curved members of the claw assembly generally form a C-shape. Both curved members may be made entirely of magnetic materials to better retain and position a nail or other metal object. In differing embodiments, a tip area of either or both curved members may be comprised of a magnet, a groove or both, to aid in grasping a nail or other metal object. The two curved members are connected via at least one hinge such that the curved members can open and close to grab and secure a nail, picture frame, hammer, shelf, bracket or other object.

Accordingly, the multi-purpose grabbing device of the present invention is particularly advantageous as it provides an improved means to perform overhead tasks. Further, the device can extend to multiple lengths, allowing for user customizability and preference. In addition, the device can decrease the stress and strain on the shoulder joint by eliminating the need for the user to extend an arm over his or her head when performing overhead tasks. In this manner, the multi-purpose grabbing device overcomes the limitations of existing grabbing devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multi-purpose grabbing device of the present invention in accordance with the disclosed architecture;

FIG. 2 illustrates a perspective view of one potential embodiment of a multi-purpose grabbing device of the present invention in accordance with the disclosed architecture;

FIG. 3 illustrates an enhanced perspective view of one potential embodiment of a multi-purpose grabbing device of the present invention in accordance with the disclosed architecture;

FIG. 4 illustrates a perspective view of one potential embodiment of a multi-purpose grabbing device of the present invention being used by a user in accordance with the disclosed architecture; and

FIG. 5 illustrates a perspective view of one potential embodiment of a multi-purpose grabbing device of the present invention being used by a user in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a multi-purpose grabbing device. There also exists a long-felt need in the art for a grabbing device that eases the strain on shoulders when completing overhead tasks. Further, there exists a long-felt need in the art for a multi-purpose grabbing device that can act as an extension of an arm to reach higher places and attach and detach to various objects. In addition, there exists a long-felt need in the art for a multi-purpose grabbing device that can accommodate users of all lengths and sizes.

The present invention, in one exemplary embodiment, is comprised of a multi-purpose grabbing device that extends from a user's hand and secures an object to it such that stress on the shoulder joint is relieved when completing overhead tasks. The device is primarily comprised of a body further comprised of a first end, an exterior shaft with at least one internal spring, and a second end. The first end is further comprised of a handle assembly with a trigger and at least one locking button. The second end is further comprised of a claw assembly. The body may also be made of a plurality of materials, but is preferably made of a flexible or semi-flexible plastic material. In addition, any surface of the body may be comprised of a plurality of indicia such as patterns, logos, emblems, images, symbols, designs, letters, words, characters, animals, advertisements, brands, etc.

Further, the body is comprised of an exterior shaft that connects a first end to a second end. The body may be of a fixed length in which the exterior shaft is rigid and non-adjustable. In an embodiment in which the length of the body is adjustable, the exterior shaft is hollow such that an interior shaft may fit inside the exterior shaft and extend outward. The exterior shaft is further comprised of a plurality of at least one continuous opening of which at least one spring-loaded locking tab can be inserted to temporarily fix the length of the body while the device is being used. A locking button may be found on the exterior shaft that locks the length of the body at a length of the user's choosing.

The first end of the shaft is further comprised of a handle assembly. The handle assembly is further comprised of a trigger, a locking button and a handle. The trigger may be pressed by the user, increasing tension in at least one spring that attaches the trigger to the hinge of the claw assembly and forcing the claw assembly to close. The trigger may then be released, decreasing/releasing tension in the spring and allowing the claw assembly to open. The spring runs inside the exterior shaft in an embodiment of the device with a fixed body length and runs inside the interior shaft in the embodiment of the device with an adjustable body length. In one potential embodiment, a trigger guard may further comprise the handle assembly to protect the trigger from being activated unintentionally. The locking button may be activated when the user intends to maintain the claw assembly in a fixed position such that it will remain closed if the claw assembly was closed when the locking button was activated. In addition, the handle of the handle assembly is where the user places a hand to operate the device. The handle is generally L-shaped and may be comprised of a textured grip to promote better grip.

The second end of the shaft is further comprised of a claw assembly. The claw assembly is further comprised of two curved members and a hinge. The curved members of the shaft assembly generally form a C-shape. The first curved member may be entirely magnetic to aid in holding a nail in one potential embodiment. In another potential embodiment, a magnet may be embedded in the end, or tip area, of the first curved member. Further, the end of the first curved member may have a semi-circular groove to allow the device to better position and retain a nail to be hammered into a wall. The second curved member makes up the other half of the C-shape of the claw assembly. The second curved member may also be entirely magnetic, or in differing embodiments, the tip area of the second curved member may have a magnet embedded into it or a semi-circular groove to better retain and position a nail. The first curved member and second curved member are attached via an at least one hinge that allows the claw assembly to open and close to retain objects. The claw assembly may also be used to hold a plurality of objects other than a nail, such as a picture frame, a hammer, a small shelf, a bracket, etc.

Accordingly, the multi-purpose grabbing device of the present invention is particularly advantageous as it provides an improved means to perform overhead tasks. Further, the device can decrease the stress on the joint of the shoulder by extending over the user's head to perform overhead tasks, eliminating the need for the user's hand or arm to do so. In addition, the device is customizable such that it can be extended to multiple lengths to accommodate people of all lengths, sizes, and flexibility. In this manner, the multi-purpose grabbing device overcomes the limitations of existing grabbing devices known in the art.

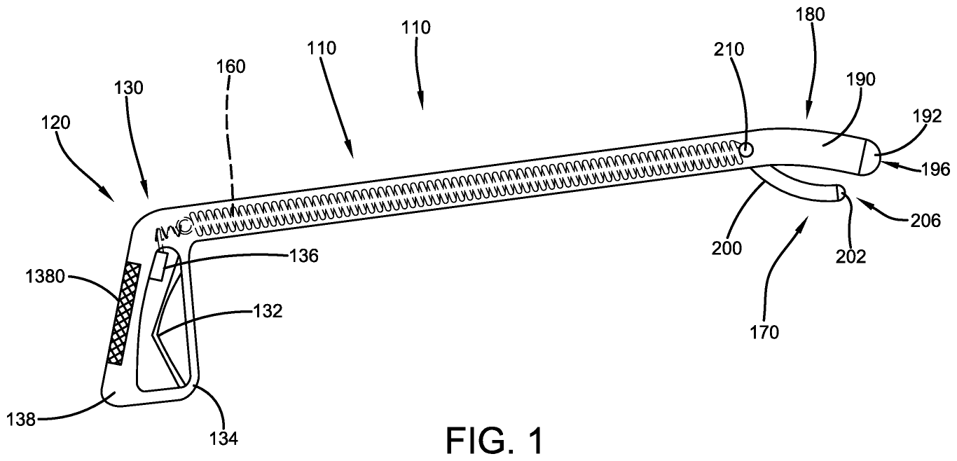

Referring initially to the drawings, FIG. 1 illustrates a perspective view of one potential embodiment of a multi-purpose grabbing device 100 of the present invention in accordance with the disclosed architecture. The device 100 is primarily comprised of a body 110 further comprised of a first end 120, an exterior shaft 140 with at least one internal spring 160, and a second end 170. The first end 120 is further comprised of a handle assembly 130 with a trigger 132 and at least one locking button 136. The second end 170 is further comprised of a claw assembly 180. In differing embodiments, the body 110 may be manufactured from a plurality of materials such as wood, stainless steel, aluminum or another type of metal, but is preferably manufactured from a flexible or semi-flexible plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In addition, the body 110 may be transparent, semi-transparent or opaque in differing embodiments. Furthermore, any surface of the body 110 may be comprised of any number of indicia 220 in the form of patterns, logos, emblems, images, symbols, designs, letters, words, characters, animals, advertisements, brands, etc.

The first end 120 of the device 100 is comprised of a handle assembly 130. The handle assembly 130 is further comprised of a trigger 132, a locking button 136 and a handle 138. Using his or her hand 20, the user 10 may activate the trigger 132 by depressing the trigger 132 which increases the tension in a spring 160 that connects to the hinge 210 of the claw assembly 180, thus closing the claw assembly 180. The spring 160 is contained in the exterior shaft 140 of the body 110, which in one embodiment is of a fixed length. However, in an embodiment where the body 110 length is adjustable, the spring 160 may be contained within the interior shaft 150. To keep the trigger 132 in a depressed position (or a position wherein it can be depressed or released), a locking button 136 may be activated, locking the trigger 132 in said depressed position and therefore locking the claw assembly 180 in a closed position, such that the claw assembly 180 cannot open unintentionally. Additionally, the locking button 136 may be activated when the claw assembly 180 is open, preventing the claw assembly 180 from closing unintentionally.

Once the trigger 132 is released, tension decreases in the spring 160 and the claw assembly 180 opens. In one potential embodiment, activating the trigger 132 and increasing tension in the spring 160 may force the claw assembly 180 open. Thus, when the trigger 132 is released and the spring 160 experiences less tension and the claw assembly 180 closes. In another potential embodiment, a trigger guard 134 may be present in the handle assembly 130, such that it may prevent the trigger 132 from being activated or deactivated unintentionally. Further, the handle 138 of the handle assembly 130 serves as a gripping point for the user's hand 20. The handle 138 is generally L-shaped and may be comprised of a textured grip 1380 to promote better grip and retention of the device 100.

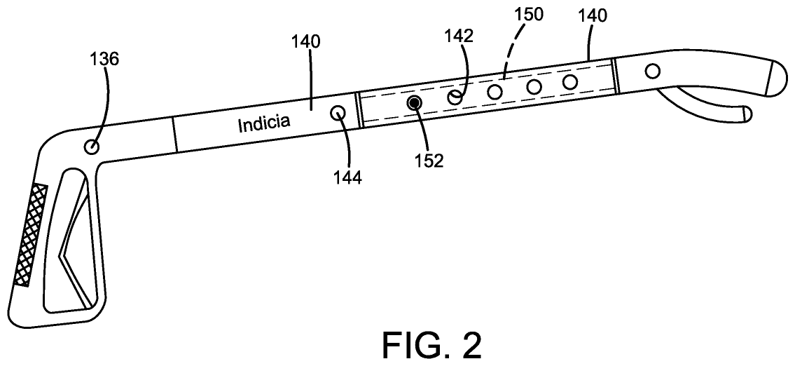

The body 110 is comprised of an exterior shaft 140 that connects a first end 120 of the device 100 to a second end 170 of the device 100. In one embodiment, the exterior shaft 140 may be of a fixed length such that the exterior shaft 140 is rigid and non-adjustable (as best seen in FIG. 1). In another potential embodiment, the exterior shaft 140 may be hollow and further comprised of at least one interior shaft 150 (as best seen in FIG. 2), that allows the device 100 to extend in length. In this embodiment, the exterior shaft 140 may have a plurality of continuous openings 142. At least one spring-loaded locking tab 152 of the interior shaft 150 may then be inserted into the continuous openings 142 of the exterior shaft 140, thereby temporarily locking the length of the device 100. A locking button 144 may also be found along the exterior shaft 140. When activated, the locking button 144 may prevent the spring-loaded locking tabs 152 from retracting accidentally.

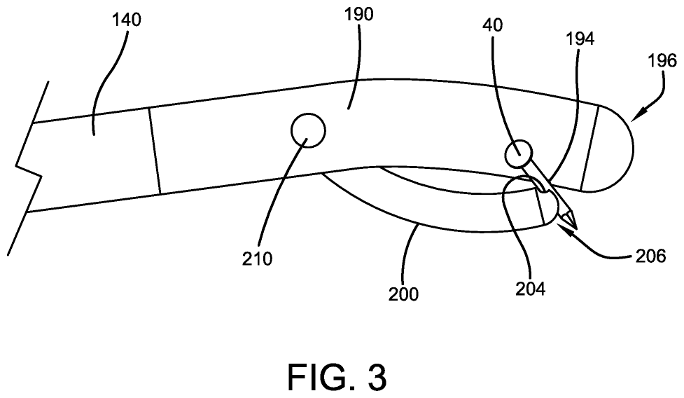

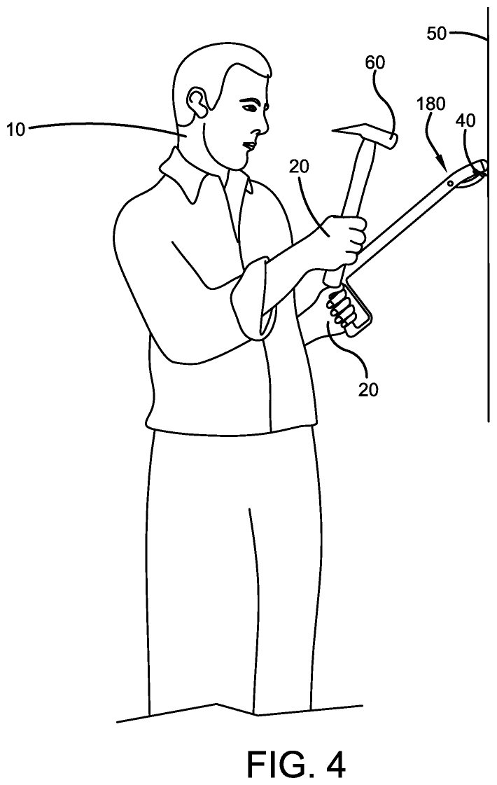

FIG. 3 illustrates an enhanced perspective view of one potential embodiment of a multi-purpose grabbing device 100 of the present invention in accordance with the disclosed architecture. The second end 170 of the device 100 is comprised of a claw assembly 180. The claw assembly 180 is further comprised of two curved members 190, 200 which are connected by at least one hinge 210. The first curved member 190 may be made entirely of a magnetic material, such that a nail 40 or other metal object may be easily grabbed. In one potential embodiment, a tip area 196 of the first curved member 190 may be comprised of a magnet 192, a groove 194 or both a magnet 192 and a groove 194 to aid in retention and positioning of a nail 40 or other similar object of the like. The second curved member 200 may also be entirely made of a magnetic material, or, in differing embodiments, a tip area 206 of the second curved member 200 may be further comprised of a magnet 202, a groove 204 or both 202, 204. The two curved members 190, 200 form a C-shaped claw assembly 180 when opened when the trigger 132 is not depressed. When closed (when the trigger 132 is depressed), the tip areas 196, 206 of the two curved members 190, 200 can be pressed into each other such that a nail 40 can be retained on or within the tip areas 196,206 and can be pressed into a wall 50 to fasten objects to the wall 50 or hang a picture frame 30 on the wall 50. By holding the nail 40 with the claw assembly 180, the user 10 eliminates the risk of hitting the non-dominant hand 20 (which would otherwise be holding the nail 40) with a hammer 60 (as best seen in FIG. 4).

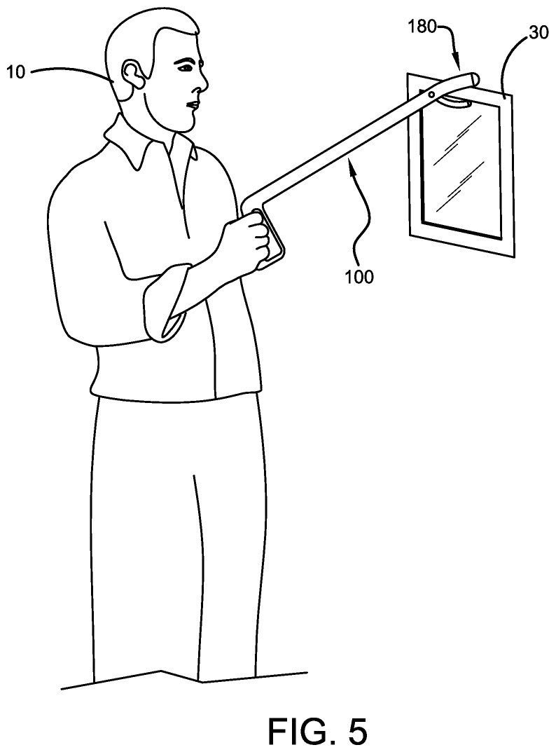

An at least one hinge 210 also connects the first curved member 190 to the second curved member 200 and preferably only moves one of the curved members 190, 200 while the other remains in a fixed position. However, in one potential embodiment, the hinge 210 may move both curved members 190, 200 of the claw assembly such that neither is in a completely fixed position. In addition, the claw assembly 180 of the device 100 may hold other objects than a nail, such as a picture frame 40 itself (as best seen in FIG. 5), a hammer, a shelf, a bracket, etc., thereby eliminating the need for the user 10 to lift his or her arms above the head and risk injury to the shoulder joint to perform various tasks that involve lifting said objects of the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-purpose grabbing device” and “device” are interchangeable and refer to the multi-purpose grabbing device 100 of the present invention.

Notwithstanding the forgoing, the multi-purpose grabbing device 100 of the present invention and its various components can be of any suitable size and configuration as is known in the art without affecting the overall concept of the invention, provided that they accomplish the above-stated objectives. One of ordinary skill in the art will appreciate that the size, configuration and material of the multi-purpose grabbing device 100 as shown in the FIGS. are for illustrative purposes only, and that many other sizes and shapes of the multi-purpose grabbing device 100 are well within the scope of the present disclosure. Although the dimensions of the multi-purpose grabbing device 100 are important design parameters for user convenience, the multi-purpose grabbing device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-purpose grabbing device comprising:
a first end comprised of a handle assembly, wherein the handle assembly is comprised of a trigger, a trigger guard, a handle and a locking button;
a second end comprised of a claw assembly, wherein the claw assembly is comprised of a first curved member having a first magnet and a second curved member having a second magnet, and wherein the first curved member and the second curved member are connected by a hinge;
an exterior shaft; and
a spring within the exterior shaft that is connected to the hinge of the claw assembly.

2. The multi-purpose grabbing device of claim 1, wherein depressing the trigger increases a tension within the spring and causes the claw assembly to close.

3. The multi-purpose grabbing device of claim 1, wherein releasing the trigger decreases a tension within the spring and causes the claw assembly to open.

4. The multi-purpose grabbing device of claim 1, wherein both the first and second curved members move when the trigger is depressed.

5. A multi-purpose grabbing device comprising:
a handle assembly positioned on a first end of the multi-purpose grabbing device and comprised of a trigger, a handle having a textured grip, and a locking button;
a claw assembly positioned on a second end of the multi-purpose grabbing device and comprised of a first curved member having a first groove and a second curved member having a second groove, wherein the first curved member and the second curved member are connected by a hinge and are repositionable relative to one another;
an exterior shaft; and
a spring positioned within the exterior shaft, wherein the spring is connected to the hinge of the claw assembly.

6. The multi-purpose grabbing device of claim 5, wherein depressing the trigger increases a tension within the spring and causes the claw assembly to close.

7. The multi-purpose grabbing device of claim 5, wherein releasing the trigger decreases a tension within the spring and causes the claw assembly to open.

8. The multi-purpose grabbing device of claim 5, wherein the locking button can be used to lock the claw assembly in a closed position or an open position.

9. The multi-purpose grabbing device of claim 5 further comprising a trigger guard.

10. The multi-purpose grabbing device of claim 5, wherein each of a first tip area of the first curved member and a second tip area of the second curved member is magnetic.

11. The multi-purpose grabbing device of claim 5, wherein both the first curved member and the second curved member articulate when the trigger is depressed.

12. A multi-purpose grabbing device comprising:
a handle assembly positioned at a first end of the multi-purpose grabbing device and comprising a trigger, a handle with a textured grip, and a locking button;
a claw assembly positioned at a second end of the multi-purpose grabbing device and comprising a first curved member, a hinge and a second curved member;
an exterior shaft comprised of a plurality of continuous openings and a locking button;
an interior shaft comprised of at least one spring-loaded locking tab; and
a spring within the interior shaft that connects to the hinge of the claw assembly.

13. The multi-purpose grabbing device of claim 12, wherein a length of the multi-purpose grabbing device is adjustable.

14. The multi-purpose grabbing device of claim 12, wherein the at least one spring-loaded tab engages a select one of the plurality of continuous openings to lock the multi-purpose grabbing device at a fixed length.

15. The multi-purpose grabbing device of claim 12, wherein the locking button of the exterior shaft allows the multi-purpose grabbing device to be locked at a fixed length.

16. The multi-purpose grabbing device of claim 12, wherein each of a tip area of the first curved member and a tip area of the second curved member is magnetic.

17. The multi-purpose grabbing device of claim 12, wherein both the first curved member and the second curved member articulate when the trigger is depressed.

18. The multi-purpose grabbing device of claim 12, wherein depressing the trigger increases a tension within the spring and causes the claw assembly to close.

19. The multi-purpose grabbing device of claim 18, wherein releasing the trigger decreases the tension within the spring and causes the claw assembly to open.

20. The multi-purpose grabbing device of claim 12, wherein the locking button can be used to lock the claw assembly in a closed position or an open position.
